(19) United States
(12) Patent Application Publication
(10) Pub. No.: US 2023/0088426 A1
(43) Pub. Date: Mar. 23, 2023

(54) TRACK BRIDGE FOR GATE VALVES FOR A TRANSPORTATION SYSTEM

(71) Applicant: HYPERLOOP TECHNOLOGIES, INC., Los Angeles, CA (US)

(72) Inventors: Yuka MATSUYAMA, Los Angeles, CA (US); John SHEW, Los Angeles, CA (US)

(73) Assignee: HYPERLOOP TECHNOLOGIES, INC., Los Angeles, CA (US)

(21) Appl. No.: 17/787,002

(22) PCT Filed: Oct. 21, 2020
(86) PCT No.: PCT/US2020/056662

§ 371 Date: Jun. 17, 2022

Related U.S. Application Data
(60) Provisional application No. 62/950,779, filed on Dec. 19, 2019.

(51) Int. Cl. F16K 3/316; F16K 3/02; E01B 25/00

(52) U.S. Cl. CPC F16K 3/316; F16K 3/02; E01B 25/00

(57) ABSTRACT

A gate valve including a gate valve door moveable between an open position and a closed position; and a track bridge moveable between a lowered active position, and a raised inactive position. When the track bridge is in the raised position, the gate valve can be moved from the open position to the closed position.

### CROSS-REFERENCE TO RELATED APPLICATION

The present application claims the benefit of U.S. Provisional Application No. 62/950,779, filed Dec. 19, 2019, the contents of which are expressly incorporated herein by reference in their entirety.

### BACKGROUND OF THE DISCLOSURE

### 1. Field of the Disclosure

The present disclosure relates to a track bridge for gate valves for a high-speed transportation system, and methods of use thereof.

### 2. Background of the Disclosure

A high speed, high efficiency transportation system may utilize a low-pressure environment in order to reduce drag on a vehicle at high operating speeds, thus providing the dual benefit of allowing greater speed potential and lowering the energy costs associated with overcoming drag forces. In embodiments, these systems may use a near vacuum (e.g., low-pressure) environment within, for example, a tubular structure. The entire span of the tubular structure (or other enclosed low-pressure environment), which is potentially hundreds of miles, is maintained at a low pressure, and thus, air is evacuated from the tubular structure in order for the system to operate.

Specific, discrete portions of the tube (or tubular structure) may need to be capable of regular re-pressurization and depressurization for access thereto (e.g., for routine maintenance and/or emergency procedures), and thus may utilize one or more gate valves along a transportation path. As the gate valve door of the gate valve is actuated into position (i.e., in the sealing position), however, a portion of the track may need to be relocated to accommodate the gate valve door. Thus, there exists a need in the art for improved gate valves and/or air locks for a high-speed transportation system.

### SUMMARY OF THE EMBODIMENTS OF THE DISCLOSURE

The novel features which are characteristic of the disclosure, both as to structure and method of operation thereof, together with further aims and advantages thereof, will be understood from the following description, considered in connection with the accompanying drawings, in which embodiments of the disclosure are illustrated by way of example. It is to be expressly understood, however, that the drawings are for the purpose of illustration and description only, and they are not intended as a definition of the limits of the disclosure.

Aspects of the disclosure are directed to a gate valve comprising: a gate valve door moveable between an open position and a closed position; and a track bridge moveable between a lowered active position, and a raised inactive position, wherein when the track bridge is in the raised position, the gate valve can be moved from the open position to the closed position.

In embodiments, the gate valve further comprises a track frame in which the track bridge is moveable between the lowered position and the raised position.

In further embodiments, the track bridge comprises a track support and side supports arranged on each side of the track support, wherein the side supports are perpendicular to the track support.

In additional embodiments, each of the side supports includes a lower portion extending below the track support.

In yet further embodiments, each of the lower portions includes a projection that projects outwardly from a lower end of the lower portion in a direction parallel to an extension direction of the track support.

In embodiments, the track bridge further comprises a first projection foot which projects outwardly from the projection in a direction perpendicular to an extension direction of the track support, and a second projection foot which projects outwardly from the projection in a direction perpendicular to the extension direction of the track support and opposite the first projection foot.

In further embodiments, the first projection foot and the second projection foot each comprise a planar contact surface for engagement with respective frame planar contact surfaces of the track frame.

In some embodiments, the track bridge further comprises a padding arranged on at least one of the planar contact surfaces a hard contact arranged on at least one of the planar contact surfaces.

In further embodiments, at least one of the first projection foot and the second projection foot comprises a tapering contact surface for engagement with respective frame tapering contact surface of the track frame.

In additional embodiments, the projection projects outwardly from a lower end of the lower portion in a direction perpendicular to an extension direction of the track support.

In yet further embodiments, the projection comprises a lopsided diamond-shaped petal.

In some embodiments, each of the side supports further includes an upper portion extending above the track support.

In further embodiments, the track frame includes projection guideways operable to accommodate respective projections of the track bridge through a range of movement of the track bridge between the lowered position and the raised position.

In embodiments, the respective projections of the track bridge arranged in the projection guideways prevent rotation of the track bridge through the range of movement of the track bridge between the lowered position and the raised position.

In further embodiments, the gate valve further comprises at least one of guidance tracks, levitation tracks, c-cores, and supplemental braking tracks arranged on the track bridge.

In additional embodiments, the gate valve further comprises transfer balls arranged on the track bridge.

In yet further embodiments, the gate valve further comprises a first actuator to move the track bridge in a vertical direction between the lowered position and the raised position; and a second actuator operable to move the gate valve between the open position and the closed position.

Aspects of the disclosure are directed to a method of operating a gate valve comprising a gate valve door moveable between an open position and a closed position; and a track bridge moveable between a lowered active position, and a raised inactive position. The method comprises raising the track bridge from the lowered active position to the raised inactive position; and moving the gate valve door from the open position to the closed position to seal the gate valve.

In embodiments, the method further comprises moving the gate valve door from the closed position to the open position; and lowering the track bridge from the raised inactive position to the lowered active position so that one or more tracks on the track bridge align with adjacent tracks on each side of the gate valve.

In further embodiments, the one or more tracks on the track bridge comprise at least one of guidance tracks, levitation tracks, c-cores, and supplemental braking tracks.

### BRIEF DESCRIPTION OF THE DRAWINGS

The novel features which are characteristic of the systems and apparatus, both as to structure and method of operation thereof, together with further aims and advantages thereof, will be understood from the following description, considered in connection with the accompanying drawings, in which embodiments of the system and apparatuses are illustrated by way of example. It is to be expressly understood, however, that the drawings are for the purpose of illustration and description only, and they are not intended as a definition of the limits of the system. For a more complete understanding of the disclosure, as well as other aims and further features thereof, reference may be had to the following detailed description of the disclosure in conjunction with the following exemplary and non-limiting drawings wherein:

FIG. 1 is a schematic view of an exemplary gate valve including a track frame, a gate valve door, and a track bridge with the gate valve door in an open position and the track bridge 110 in the lowered (active) position in accordance with embodiments of the present disclosure;

FIG. 2 is a schematic view of the exemplary gate valve and track bridge of FIG. 1, with the gate valve door closed and the track bridge in the raised (inactive) position in accordance with embodiments of the present disclosure;

FIG. 3 illustrates a view of an exemplary gate valve housing arranged in along a transportation path of the transportation system in accordance with embodiments of the present disclosure;

FIG. 4 illustrates a schematic top view of an exemplary gate valve and track bridge in accordance with embodiments of the present disclosure;

FIG. 5 illustrates a schematic top view of an exemplary gate valve (with the gate valve door in a closed position) and track bridge with the guidance rails, the levitation rails, the C-cores, and the supplemental braking system (SBS) rails in accordance with embodiments of the present disclosure;

FIG. 6 illustrates a perspective schematic view of an exemplary track bridge in accordance with embodiments of the present disclosure;

FIG. 7 illustrates a perspective schematic view of the exemplary track bridge of FIG. 6 and top schematic view of the exemplary track bridge in the track frame with transfer balls depicted in accordance with embodiments of the present disclosure;

FIG. 8 illustrates a close-up perspective view of the exemplary track bridge of FIG. 6 in the track frame (e.g., gate valve housing) in the lowered (active) position in accordance with embodiments of the present disclosure;

FIG. 9 illustrates a top view of the exemplary gate valve having a track frame and track bridge with the gate valve door in the open position and the track bridge in the lowered (active) position in accordance with embodiments of the present disclosure;

FIG. 10 illustrates a perspective schematic view another exemplary track bridge in accordance with embodiments of the present disclosure;

FIG. 11 illustrates a perspective schematic view of another exemplary track bridge and schematic top view of corresponding track frame for the exemplary track bridge in accordance with embodiments of the present disclosure;

FIGS. 12 and 13 are a schematic views of another exemplary gate valve with a track frame and the track bridge of FIG. 11 with the gate valve door in the open position and the track bridge in the lowered (active) position in accordance with embodiments of the present disclosure;

FIG. 14 is a schematic view of the exemplary gate valve having the track guide and track bridge of FIGS. 12 and 13 with the gate valve door in the closed position and the track bridge in the raised (inactive) position in accordance with embodiments of the present disclosure;

FIG. 15 illustrates a top view of the exemplary gate valve having the track guide and track bridge of FIG. 12 with the gate valve door in the open position and the track bridge in the lowered (active) position (or in a raised inactive position) in accordance with embodiments of the present disclosure;

FIG. 16 illustrates a close-up perspective view of the exemplary track bridge of FIG. 12 in the gate valve housing in the lowered (active) position in accordance with embodiments of the present disclosure; and

FIG. 17 shows an exemplary environment for practicing aspects of the present disclosure.

### DETAILED DESCRIPTION OF THE EMBODIMENTS OF THE DISCLOSURE

In the following description, the various embodiments of the present disclosure will be described with respect to the enclosed drawings. As required, detailed embodiments of the embodiments of the present disclosure are discussed herein; however, it is to be understood that the disclosed embodiments are merely exemplary of the embodiments of the disclosure that may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the present disclosure.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, such that the description, taken with the drawings, making apparent to those skilled in the art how the forms of the present disclosure may be embodied in practice.

As used herein, the singular forms “a,” “an,” and “the” include the plural reference unless the context clearly dictates otherwise. For example, reference to “a magnetic material” would also mean that mixtures of one or more magnetic materials can be present unless specifically excluded.

Except where otherwise indicated, all numbers expressing quantities used in the specification and claims are to be understood as being modified in all instances by the term “about.” Accordingly, unless indicated to the contrary, the numerical parameters set forth in the specification and claims are approximations that may vary depending upon the desired properties sought to be obtained by embodiments of the present disclosure. At the very least, and not to be considered as an attempt to limit the application of the doctrine of equivalents to the scope of the claims, each numerical parameter should be construed in light of the number of significant digits and ordinary rounding conventions (unless otherwise explicitly indicated).

Additionally, the recitation of numerical ranges within this specification is considered to be a disclosure of all numerical values and ranges within that range (unless otherwise explicitly indicated). For example, if a range is from about 1 to about 50, it is deemed to include, for example, 1, 7, 34, 46.1, 23.7, or any other value or range within the range. Moreover, these exemplary ranges do not exclude other ranges or values that may be outside this exemplary range.

The various embodiments disclosed herein can be used separately and in various combinations unless specifically stated to the contrary.

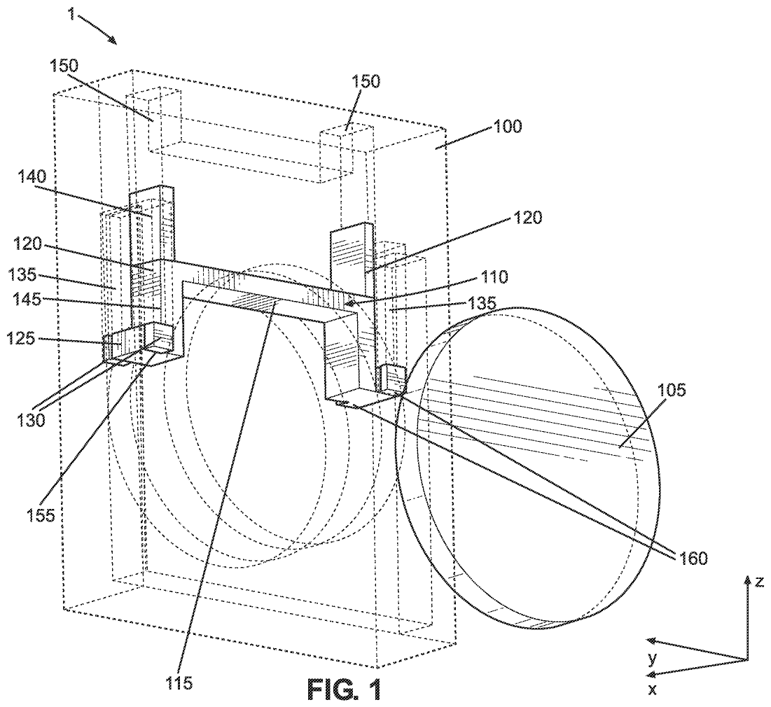

FIG. 1 is a schematic view of an exemplary gate valve 1 including a track frame 100, a gate valve door 105, and a track bridge 110 with the gate valve door 105 in an open position and the track bridge 110 in the lowered (active) position in accordance with embodiments of the present disclosure. As shown in FIG. 1, when in the lowered (or active) position, the track bridge 110 is arranged such that track elements (e.g., levitation tracks (or rails), guidance tracks, c-cores and secondary braking system rails) of the transportation system are properly located (i.e., aligned with adjacent tracks) to allow the vehicle (e.g. pod) to traverse the transportation path through the gate valve 1. It should be noted that the track elements are not shown in FIG. 1. In accordance with aspects of the disclosure, the track elements (not shown) are attached to the track bridge 110 so as to move (vertically) with the track bridge between the lowered (or active) position and a raised (or inactive) position.

As shown in FIG. 1, the track bridge 110 may include a track support 115 and side supports 120 arranged on each side of the track support 115, wherein the side supports 120 are perpendicular to the track support 115. Each of the side supports 120 includes a lower portion 145 extending below the track support 115. In embodiments, tracks (e.g., guidance tracks, levitation tracks, c-cores, and/or supplemental braking tracks) may be arranged on the track support 115 and/or the side supports 120 (e.g., the lower portions 145 thereof).

As shown in the exemplary embodiment of FIG. 1, each of the lower portions 145 includes a projection 125 that projects outwardly from a lower end of the lower portion 145 in a direction parallel to an extension direction of the track support 115 (i.e., y-direction). As shown in FIG. 1, a first projection foot 130 projects outwardly from the projection 125 in a direction perpendicular to an extension direction of the track support 115, and a second projection foot 130 that projects outwardly from the projection in a direction perpendicular to the extension direction of the track support and opposite the first projection foot. In embodiments, the projection feet on a respective lower portion 145 can have a same shape/configuration or different shape/configurations as compared to each other. As shown in FIG. 1, with this exemplary embodiment, the first projection foot 130 and the second projection foot 130 each comprise a planar contact surface 155 for engagement with respective frame planar contact surfaces 160 of the track frame 100.

As shown in FIG. 1, with this exemplary embodiment each of the side supports 120 further includes an upper portion 140 extending above the track support 115. The track frame 100 includes projection guideways 135 operable to accommodate respective projections 125 (including projection feet 130) of the track bridge 110 through a range of movement of the track bridge 110 between the lowered position and the raised position. In accordance with aspects of the disclosure, the respective projections 125 of the track bridge 110 arranged in the projection guideways 135 prevent rotation of the track bridge 110 through the range of movement of the track bridge between the lowered position and the raised position, so that when the track bridge is in the lowered (or operational) position, the tracks arranged thereon (not shown) are properly aligned (e.g., around the x-, y-, and/or z-axis) with upstream and downstream segments of tracks (not shown). As shown in FIG. 1, the track frame 100 includes recesses 150 to accommodate the upper portions 140 of the side frames 120 (when the track bridge 110 is raised). In embodiments, inner walls of the track frame 100 may be guiding surfaces for the track bridge 110 (e.g., the upper leg portions 140 and the lower leg portions 145) and may be sized accordingly (e.g., with sufficient clearances).

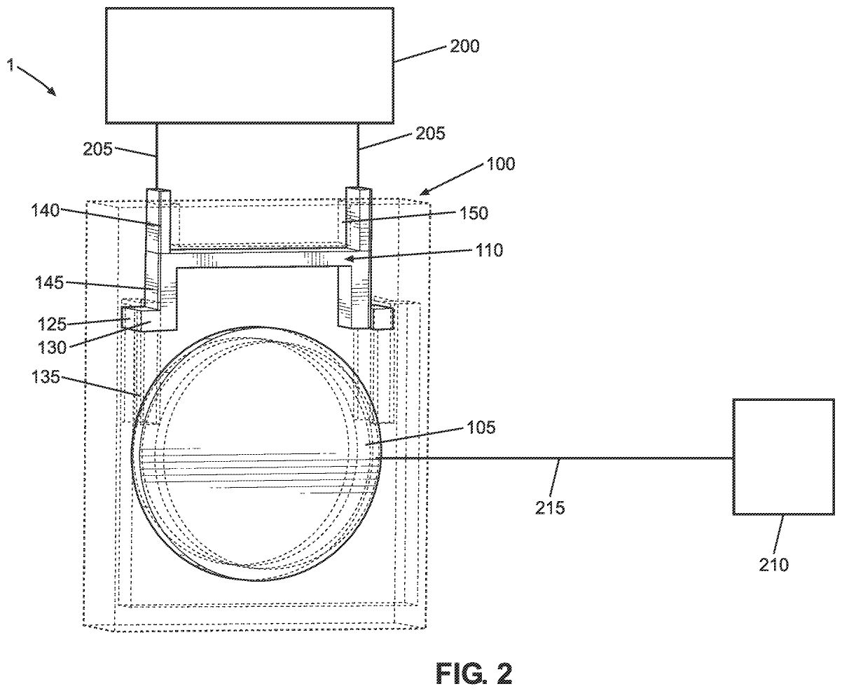

FIG. 2 is a schematic view of the exemplary gate valve 1 and track bridge 110 of FIG. 1, with the gate valve door 105 closed and the track bridge 110 in the raised (inactive) position in accordance with embodiments of the present disclosure. In accordance with aspects of the disclosure, as the gate valve door 105 of the gate valve is (or prior to being) actuated into the closed (or sealing) position in the track frame 100 by moving laterally, the track bridge 110 is operable to move in the track frame 100 to relocate a portion of the track (not shown), e.g., moved upwardly, to accommodate the gate valve door 105 in the sealing position. As shown in FIG. 2, when the track bridge 110 is moved upwardly, clearance is provided for the gate valve door 105 to move laterally in the track frame 100 into a sealing (or closed) position. As shown in FIG. 2, when arranged in the raised (inactive) position, the upper portions 140 of each of the side supports 120 are accommodated in the recesses 150, and the respective projections 125 of the track bridge 110 are arranged at (or near) the upper extent of the projection guideways 135.

As shown in FIG. 2, a first actuator 200 is operable to move the track bridge 110 in a vertical direction between the lowered position and the raised position, for example, via connectors 205 connected to the upper portions 140 of the side supports 120. A second actuator 210 is operable to move the gate valve door 105 between the open position and the closed position, for example, via a connector 215 (e.g., link arm).

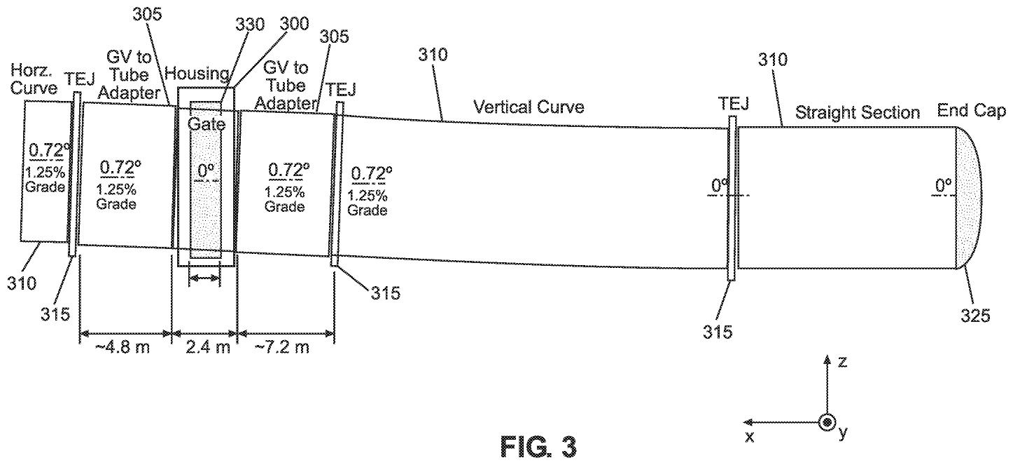

FIG. 3 illustrates a view of an exemplary gate valve housing 300 arranged along a transportation path of the transportation system in accordance with embodiments of the present disclosure. As shown in FIG. 3, the gate valve housing 300 may be arranged between two gate valve-to-tube adapters 305, which in turn may be connected to other tubes 310 of the transportation system. Additionally, as shown in the exemplary and non-limiting embodiment of FIG. 3, thermal expansion joints (TEJ) 315 may be arranged between the other tubes 310 and the gate valve-to-tube adapters 305. As shown in FIG. 3, the other tubes 310 may have a horizontal curve, a vertical curve, or may be a straight section. With a non-limiting and exemplary embodiment, the gate valve housing 300 may have a width of 2.4 meters (e.g., which represent a exemplary gate valve width) and the adjacent gate valve-to-tube adapters 305 may have widths of approximately 4.8 meters and approximately 7.2 meters, with other widths depending upon the width of the gate valve accommodated in the gate valve housing, amongst other factors. It should be understood that the disclosure contemplates a larger gate valve width, for example, if the adapter pieces are included as part of the gate valve design itself. In many contemplated embodiments, however, it may be advantageous for the gate valves to be smaller (for example, gate valve door widths of ˜0.7 to ˜1.2 m). Other contemplated gate valve door widths (or thicknesses) include even smaller thickness e.g., approximately 150 mm. Additionally, it should be understood that the total 14.4 m combined dimension shown in FIG. 3 is an exemplary and non-limiting embodiment for gate valve adapters and a gate valve.

In contemplated embodiments, the interface between gate valve 300 and gate valve-to-tube adapters 305 (e.g., concrete adapter) may include: welding to metal piece embedded in concrete adapter; grouting between adapter and gate valve flange; and/or a thermal expansion joint between the gate valve 300 and the gate valve-to-tube adapter 305. In embodiments, the interface attachment method should compensate for any difference in angle between gate valve and adapter (for example, as shown in the exemplary and non-limiting embodiment of FIG. 3).

As also shown in the exemplary and non-limiting tube arrangement of FIG. 3, an end cap 325 may be arranged at an end of the straight tube section, as this exemplary tube portion represents an end of the transportation path, in which a vehicle may be traveling at relatively lower speeds (e.g., 5 m/s). It should be understood, however, that the gate valves 300 are not limited to low speed sections, nor are they limited to being located near end caps 325. In accordance with aspects of embodiments of the disclosure, gate valves may be arranged in both low speed sections (e.g. in portals) and high speed sections (e.g., in the middle of a main route). As shown in FIG. 3, the gate valve door 330 is arranged in the gate valve housing 300 and moveable in the y-direction to move the gate valve door 330 into and out of a sealing position.

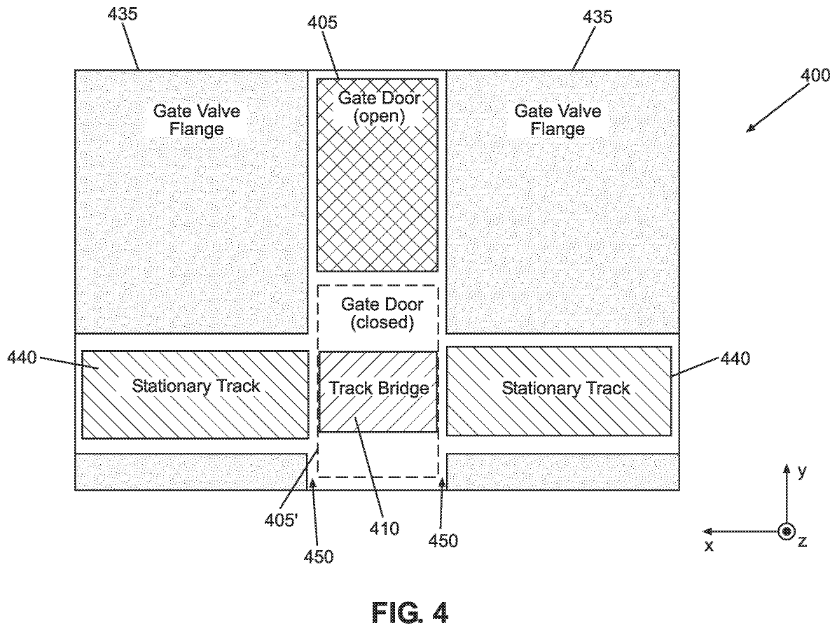

FIG. 4 illustrates a schematic top view of an exemplary gate valve 400 and track bridge 405 in accordance with embodiments of the present disclosure. With this exemplary embodiment, the gate valve door 405 (shown in the open position to the side of the transportation path) may have a width or thickness (i.e., in the x-direction) of approximately 0.5 to 1 meter, with other widths contemplated by the disclosure. In accordance with aspects of the disclosure, the track bridge 410 (and the track sections thereon) are aligned with the upstream and downstream stationary track sections 440 so that a vehicle (not shown) traveling along the transportation path can traverse the track bridge 410 when the gate door 405 is open. When the gate valve door 405′ is in a closed position (as shown in the dashed lines), the track bridge 410 is retracted (e.g., upwardly from the transportation path in the Z-direction) so that the gate valve door 405′ can be accommodated in the closed position along the transportation path. While the exemplary embodiment of FIG. 4 depicts the adjacent gate valve flanges 435 as being of equal length, it should be understood that one of the adjacent gate valve flanges may be shorter and the other of the adjacent gate valves may be longer, as long as the total length of the gate valve is maintained. In accordance with embodiments of the disclosure, the gate door and/or track bridge may be more critical or dictated lengths, whereas flange lengths may range from a minimum dimension necessary for structural integrity with no maximum dimension, although the exact sizing in embodiments may be dictated to some extent by c-core spacing and track requirements. The exemplary embodiment of FIG. 4 also shows a door clearance 450 on each side of the gate valve door 405′ and the adjacent stationary tracks 440 and housing (in the x-direction). With an exemplary and non-limiting embodiment, the clearance 450 may be approximately 30-60 mm. With an exemplary and non-limiting embodiment, the total gate valve length including connections to mating tub segments may be 2.4 meters.

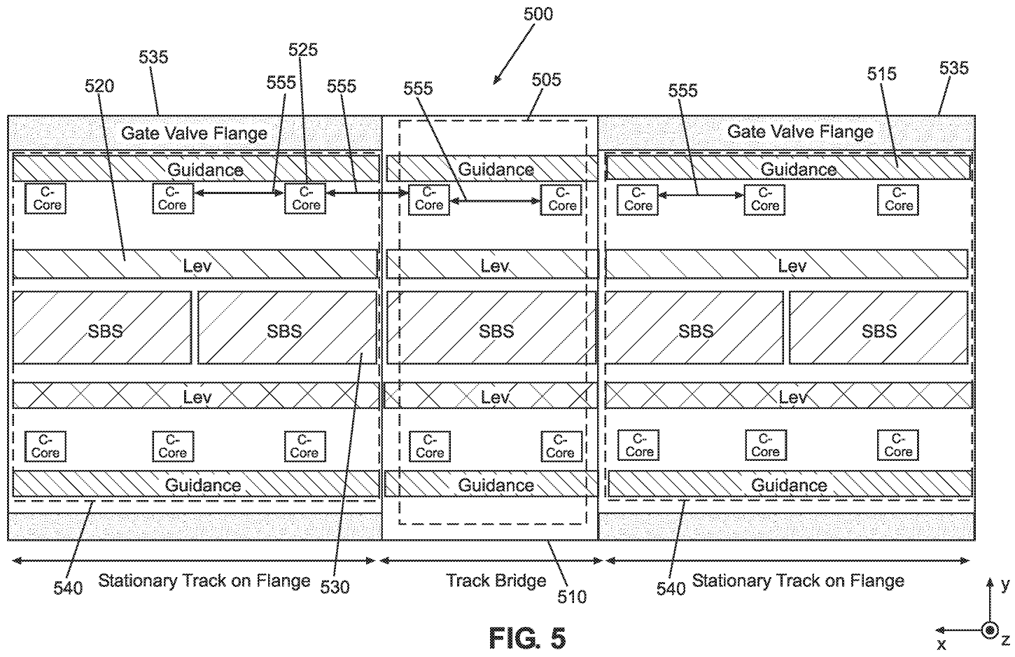

FIG. 5 illustrates a schematic top view of an exemplary gate valve 500 (with the gate valve door 505 in a closed position) and track bridge 510 with the guidance rails 515, the levitation rails 520, the C-cores 525, and the supplemental braking system (SBS) 530 rails in accordance with embodiments of the present disclosure. As shown in FIG. 5, the stationary track sections also include the guidance rails 515, the levitation rails 520, the C-cores 525, and the supplemental braking system (SBS) 530 rails. In accordance with aspects of the disclosure, the width of the gate valve door and the corresponding width of the track bridge 510 may be determined by providing the appropriate number of C-cores 525 in the track bridge 510 with the appropriate spacing 555 between adjacent C-cores 525. That is, as shown in FIG. 5, the spacing 555 of the C-cores 525 (and the length of each of the C-cores 525) may be uniform along the transportation path. As shown in the exemplary and non-limiting embodiment of FIG. 5, the track bridge 510 is structured to accommodate two C-cores 525 on each side of the transportation path and the other rails on the track bridge 510 (e.g., guidance rails 515, the levitation rails 520, and the supplemental braking system (SBS) 530 rails) are sized (e.g., have lengths) that correspond with the length of the track bridge 510. Similarly, the length of the gate valve flanges 535 may be determined by providing the appropriate number of C-cores 525 in the gate valve flanges 535 with the appropriate spacing 555 between adjacent C-cores 525.

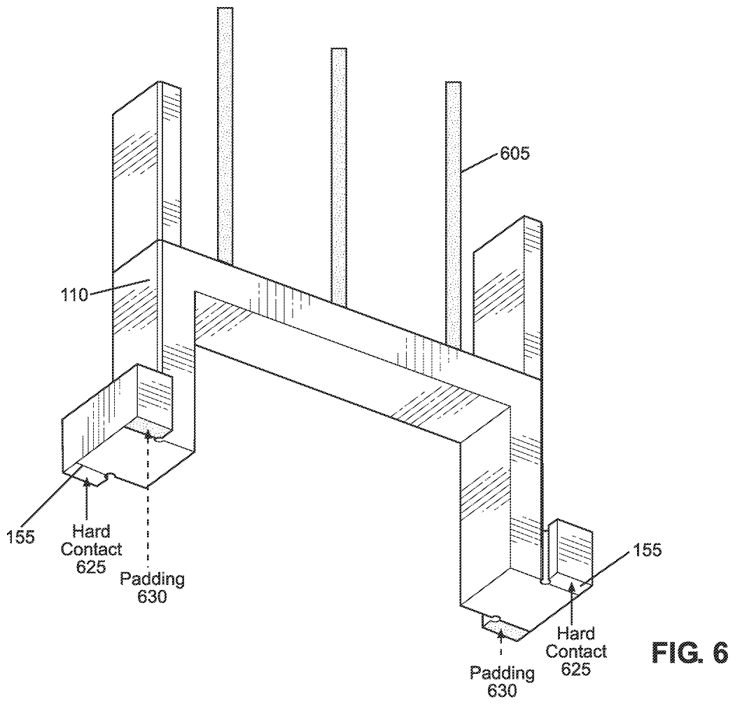

FIG. 6 illustrates a perspective schematic view of an exemplary track bridge 110 in accordance with embodiments of the present disclosure (without illustrating the tracks). As shown in FIG. 6, the track bridge 110 is operable to move vertically using hydraulic actuation (e.g., via actuators 605) with a closing valve to lock the track bridge 110 in position. Thus, once moved into a position, the valve is locked to prevent further movement (e.g., in the Z-direction). When seated in the active position, the track bridge 110 is configured to sit on ledges (not shown) in a housing (or track frame therein) to maintain the track bridge 110 in the correct orientation in the z-direction (vertical). In embodiments, a padding 630 is arranged on at least one of the planar contact surfaces 155, and a hard contact 625 is provided/arranged on at least one of the planar contact surfaces 155. For example, as shown in FIG. 6, on two opposite corners of the track bridge 600, hard contacts 625 may be provided, whereas on the other two opposite corners padding 630 may be arranged. In accordance with aspects of the disclosure, the padding 630 allows for some movement or misalignment of the track bridge 110 to be absorbed.

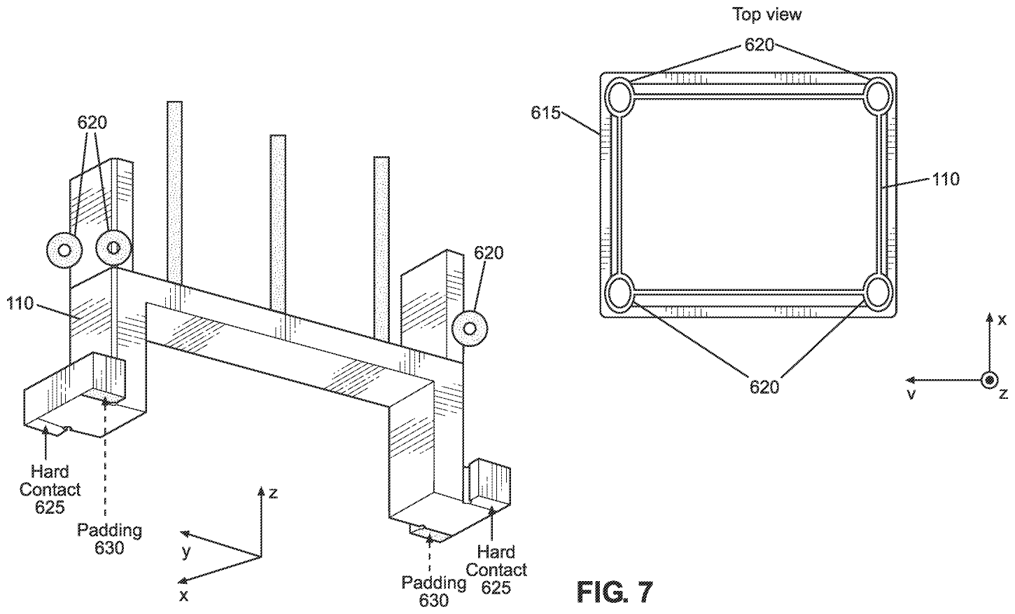

FIG. 7 illustrates a perspective schematic view of the exemplary track bridge 110 of FIG. 6 and top schematic view of the exemplary track bridge 110 in the track frame 615 with transfer balls 620 depicted in accordance with embodiments of the present disclosure. As shown in FIG. 7, the transfer balls 620 may be arranged in an upper region of the track bridge 110. As the transfer balls 620 may be arranged in an upper region of the track bridge 110, this embodiment may require additional vertical space and a larger stroke length. As shown in the top view of the track bridge 110 arranged in the track frame 615, the track bridge 110 may include transfer balls 620 that may be arranged at corners of the track bridge 110. In other contemplated embodiments, configurations may include brackets, etc., such that transfer balls could be used but not required to be in each or any of the corners (e.g., brackets could be arranged to support one or move transfer balls located at centers of the walls of the track frame 615).

In accordance with aspects of the disclosure, the transfer balls 620 allow the track bridge 110 to move vertically in the housing so as to maintain the track bridge 110 in the proper position in the X- and Y-directions (that is along the transportation path and across the width of the transportation path). With this exemplary embodiment, the padding 630 and hard contacts 625 provide a good Z-load distribution. As noted above, however, this exemplary embodiment may require additional vertical space and/or a larger stroke length.

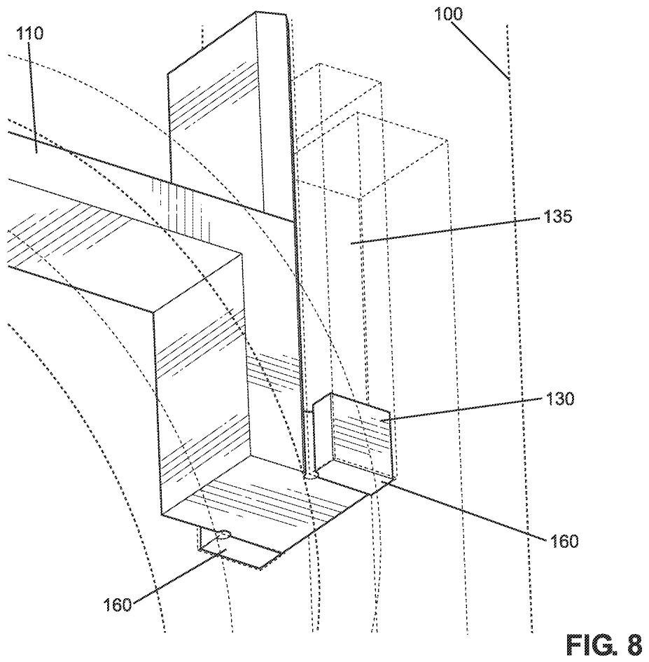

FIG. 8 illustrates a close-up perspective view of the exemplary track bridge 110 of FIG. 6 in the track frame 100 (e.g., gate valve housing) in the lowered (active) position in accordance with embodiments of the present disclosure. When seated in the active position, the track bridge 110 is configured to sit on ledges 160 in the track frame 100 to maintain the track bridge 110 in the correct orientation in the z-direction (vertical). Additionally, as shown in FIG. 8, the track frame 100 has channels 135 in which projection arms 130 of the track bridge 110 may slide vertically.

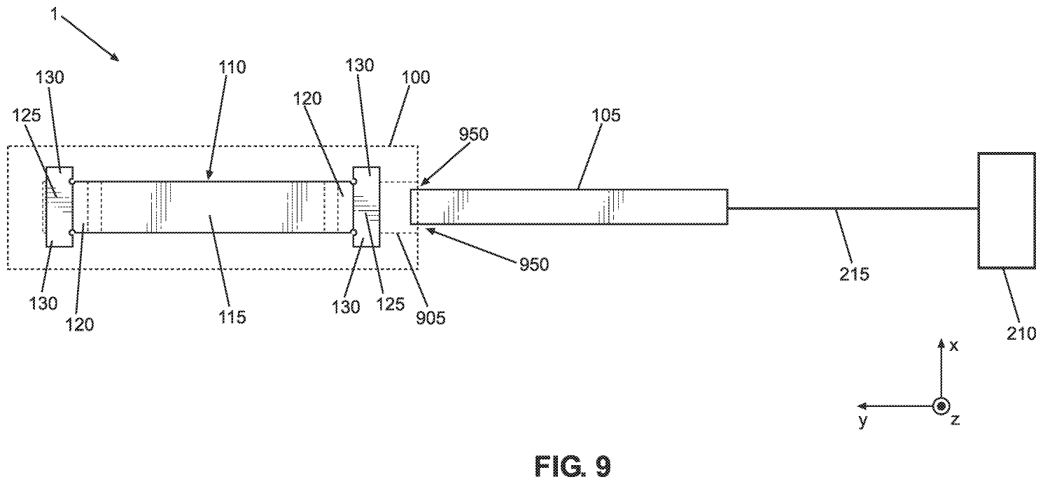

FIG. 9 illustrates a top view of the exemplary gate valve 1 having a track frame 100 and track bridge 110 with the gate valve door 105 in the open position and the track bridge 110 in the lowered (active) position in accordance with embodiments of the present disclosure. An actuator 210 is operable to move the gate valve door 105 between the open position and the closed position, for example, via a connector 215 (e.g., link arm).

As shown in FIG. 9, the track bridge 110 may include a track support 115 and side supports 120 arranged on each side of the track support 115, wherein the side supports 120 are perpendicular to the track support 115. Each of the side supports 120 includes a projection 125 that projects outwardly from a lower end of the lower portion of the side support 120 in a direction parallel to an extension direction of the track support 115 (i.e., y-direction). As shown in FIG. 9, a first projection foot 130 projects outwardly from the projection 125 in a direction perpendicular to an extension direction of the track support 115, and a second projection foot 130 that projects outwardly from the projection in a direction perpendicular to the extension direction of the track support and opposite the first projection foot.

As also shown in FIG. 9, the gate valve door 105 is moved through an opening 905 in the track frame 100 as the gate valve door 105 is moved between the sealing position and an open position. The exemplary embodiment of FIG. 9 also shows a door clearance 950 on each side of the gate valve door 105 and the opening 905 in the track frame 100 (in the x-direction). In an exemplary and non-limiting embodiment, the clearance 950 may be approximately 30-60 mm.

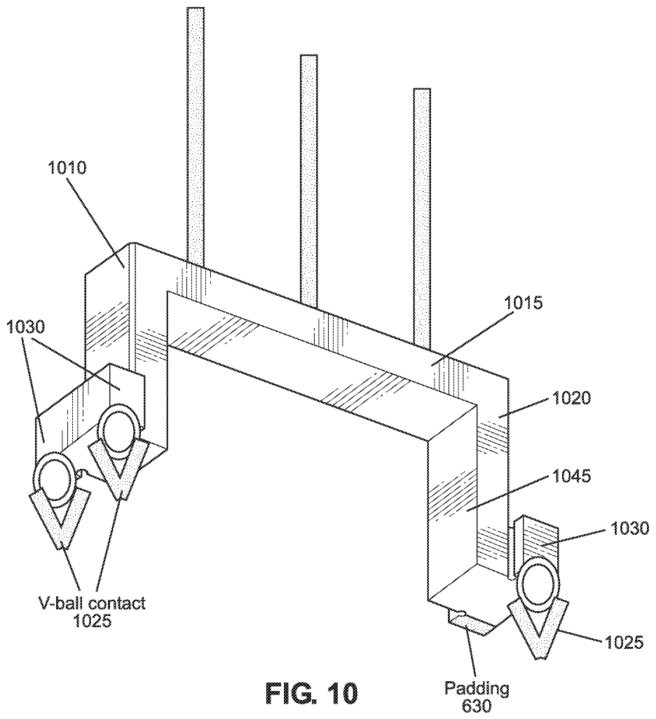

FIG. 10 illustrates a perspective schematic view another exemplary track bridge 1010 in accordance with embodiments of the present disclosure. With this exemplary track bridge 1010, the four projection arms 1030 include three that have v-ball (or conical-ball) contacts 1025 and one projection arm with padding 630. In accordance with aspects of the disclosure, when the track bridge 1010 is lowered to the active position, the v-ball contacts 1025 will engage with correspondingly-sized v-grooves provided on ledges in a track frame (not shown), so that the track bridge 1010 is operable to self-center into proper position (e.g., in the x- and y-directions).

As shown in FIG. 10, the track bridge 1010 may include a track support 1015 and side supports 1020 arranged on each side of the track support 1015, wherein the side supports 1020 are perpendicular to the track support 1015. Each of the side supports 1020 includes a lower portion 1045 extending below the track support 1015. With this exemplary embodiment, however, each of the side supports 1020 does not include an upper portion extending above the track support 1015. With this exemplary embodiment, the housing may be more vertically compact (as this embodiment does not utilize transfer balls and does not include upper portions). It should be noted that the balls (or spheres) of the v-ball contacts 1025 may need to be largely-sized to carry the weight and load of the track bridge 1010 and traveling vehicle (not shown).

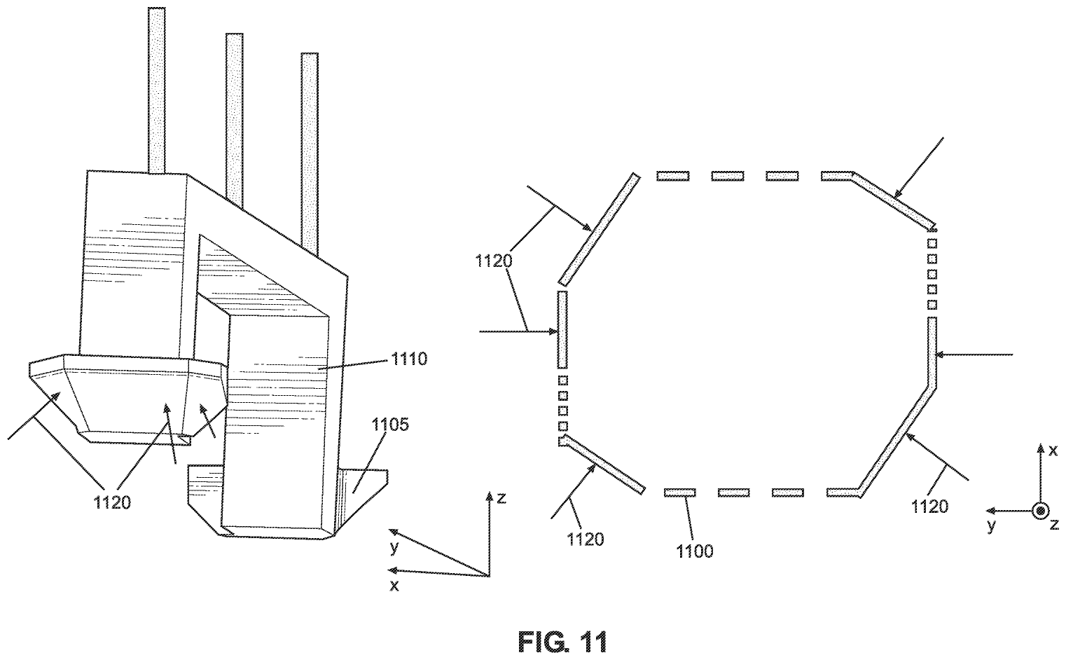

FIG. 11 illustrates a perspective schematic view of another exemplary track bridge 1110 and schematic top view of corresponding track frame 1100 for the exemplary track bridge 1110 in accordance with embodiments of the present disclosure. With this exemplary embodiment, the track bridge 1110 includes lopsided diamond-shaped petals 1105 as projections, which are structured to provide proper alignment (e.g., in the X- and Y-directions) of the track bridge 1100 as it is moved vertically and tapered so as to self-center upon engagement with corresponding recesses in a track frame (not shown). With this exemplary embodiment, the track bridge housing (or gate housing) having the track frame 1100 and the track bridge 1110 can be more vertically compact. As shown in FIG. 11, the projection 1105 projects outwardly from a lower end of the lower portion in a direction perpendicular to an extension direction of the track support and parallel to an extension direction of the track support. As shown in FIG. 11, discernable from the top view of the track frame 1100, with this exemplary embodiment, the outer profile of each lopsided diamond-shaped petal projections 1105 is the same shape, rotated by 180 degrees and asymmetric in the X-direction. As shown in the perspective schematic view, the forces 1120 on the projection 1105 serve to self-center the track bridge 1110 upon engagement with corresponding recesses in a track frame (not shown). As shown in the perspective top view, the forces 120 provide proper alignment (e.g., in the X- and Y-directions) of the track bridge 1100 as it is moved vertically.

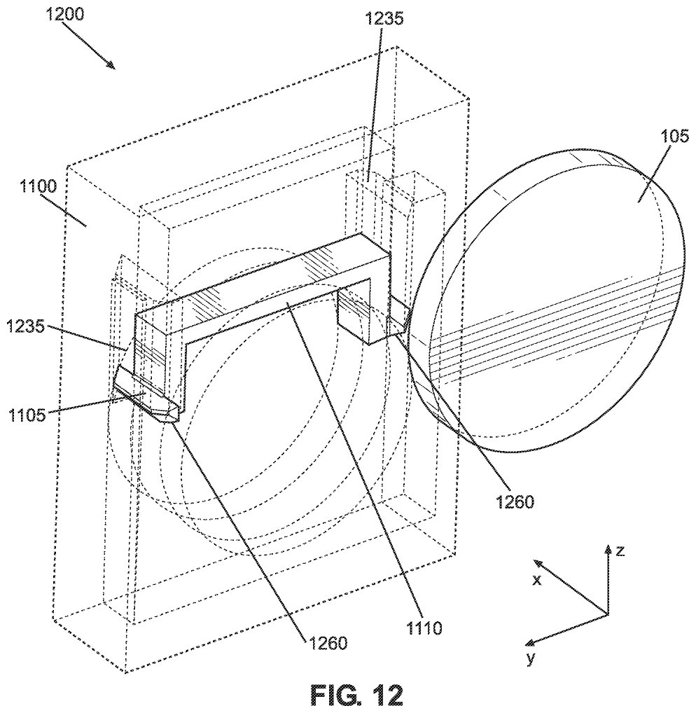

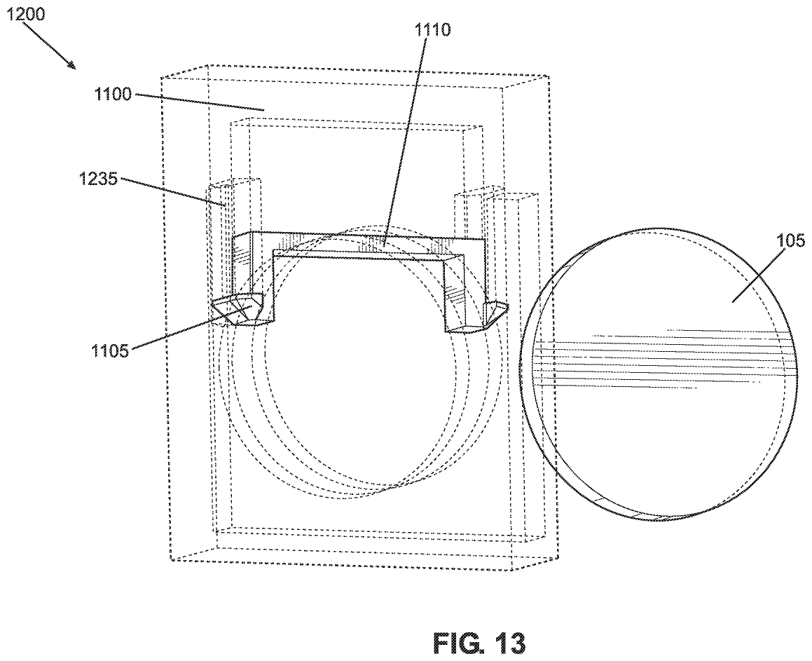

FIGS. 12 and 13 are a schematic views of another exemplary gate valve 1200 with a track frame 1100 and the track bridge 1110 of FIG. 11 with the gate valve door 105 in the open position and the track bridge 1110 in the lowered (active) position in accordance with embodiments of the present disclosure. As shown in FIGS. 12 and 13, the track bridge 1110 includes lopsided diamond-shaped petals 1105 as projections, which are structured to provide proper alignment (e.g., in the X- and Y-directions) of the track bridge 1100 as it is moved vertically in a track guides 1235 and tapered so as to self-center (e.g., in the X- and Y-directions) upon engagement with corresponding recesses 1260 in a track frame 1100 (and proper alignment in the Z-direction).

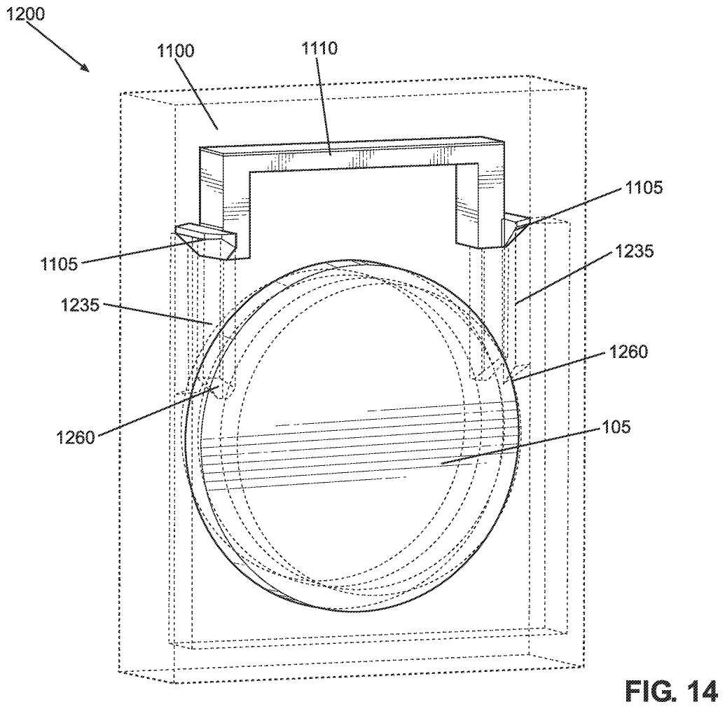

FIG. 14 is a schematic view of the exemplary gate valve 1200 having the track guide 1100 and track bridge 1110 of FIGS. 12 and 13 with the gate valve door 105 in the closed position and the track bridge 1110 in the raised (inactive) position in accordance with embodiments of the present disclosure. As shown in FIG. 14, the lopsided diamond-shaped petals 1105 are arranged at the upper end of the track guide 1235 (and the corresponding recesses 1260 of the track guide 1235 in the track frame 1100 are observable).

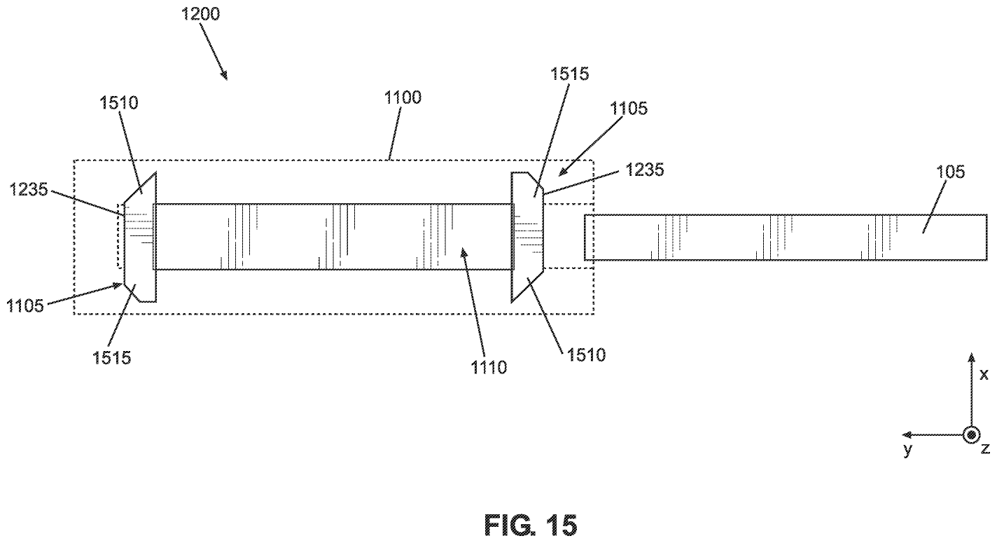

FIG. 15 illustrates a top view of the exemplary gate valve 1200 having the track guide 1100 and track bridge 1110 of FIG. 12 with the gate valve door 105 in the open position and the track bridge 1110 in the lowered (active) position (or in a raised inactive position) in accordance with embodiments of the present disclosure. With this exemplary embodiment, the track bridge 1110 includes lopsided diamond-shaped petals 1105 as projections, which are structured to provide proper alignment (e.g., in the X- and Y-directions) of the track bridge 1100 as it is moved vertically in track guides 1235 and tapered so as to self-center (e.g., in the X- and Y-directions) upon engagement with corresponding recesses in a track frame (not shown), and proper alignment in the Z-direction. With this exemplary embodiment, the gate bridge housing having the track frame 1100 and the track bridge 1110 can be more vertically compact. As shown in FIG. 15, the projection 1105 projects outwardly from a lower end of the lower portion in a direction perpendicular to an extension direction of the track support and parallel to an extension direction of the track support. As shown in FIG. 15, with the track frame 1100, the outer profile of each lopsided diamond-shaped petals projection 1105 is the same, rotated by 180 degrees and asymmetric in the X-direction. The lopsided diamond-shaped petal projections 1105 may include a first projection 1510 (for example, having a triangle profile when viewed in the Z-direction) and a second projection 1515 (with, for example, a “chamfered” profile when viewed in the Z-direction).

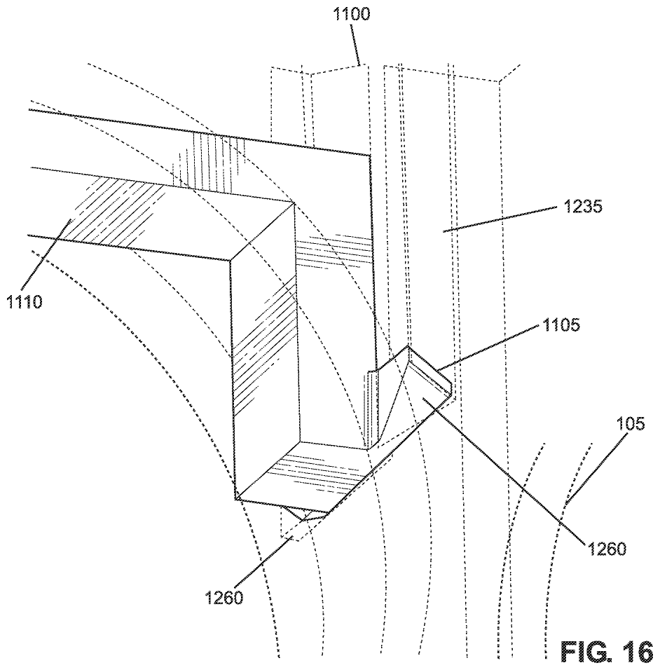

FIG. 16 illustrates a close-up perspective view of the exemplary track bridge 1110 of FIG. 12 in the track frame 1100 in the lowered (active) position in accordance with embodiments of the present disclosure. As shown in FIG. 16, the track bridge 1110 includes lopsided diamond-shaped petal projections 1105, which are structured to provide proper alignment (e.g., in the X- and Y-directions) of the track bridge 1100 as it is moved vertically in the track guide 1235 and tapered so as to self-center (e.g., in the X- and Y-directions) upon engagement with corresponding recesses 1260 in a track frame 1100 (and proper alignment in the Z-direction).

Some elements of a gate valve for a high-speed transportation system are discussed in related and commonly-assigned U.S. Pat. No. 9,599,235, entitled “GATE VALVES AND AIRLOCKS FOR A TRANSPORTATION SYSTEM,” the entire contents of which are expressly incorporated by reference herein in their entirety.

The illustrations of the embodiments described herein are intended to provide a general understanding of the various embodiments. The illustrations are not intended to serve as a complete description of all of the elements and features of apparatus and systems that utilize the structures or methods described herein. For example, while the discussed embodiments utilize a vertically moveable track bridge and a horizontally moveable gate valve door, the disclosure contemplates that both the track bridge and the gate valve door may be horizontally actuated or vertically actuated. With other contemplated embodiments, the track may remain stationary, while the door is slid around the track. In yet further contemplated embodiments, the track may remain stationary (i.e., no track bridge), but the gate valve door (e.g., having multiple door sections) may partially move horizontally (e.g., one door section) and partially move vertically (e.g., another door section).

### System Environment

Aspects of embodiments of the present disclosure (e.g., control systems for the track bridge and gate valve) can be implemented by such special purpose hardware-based systems that perform the specified functions or acts, or combinations of special purpose hardware and computer instructions and/or software, as described above. The control systems may be implemented and executed from either a server, in a client server relationship, or they may run on a user workstation with operative information conveyed to the user workstation. In an embodiment, the software elements include firmware, resident software, microcode, etc.

As will be appreciated by one skilled in the art, aspects of the present disclosure may be embodied as a system, a method or a computer program product. Accordingly, aspects of embodiments of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure (e.g., control systems) may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, a magnetic storage device, a usb drive, and/or a mobile phone.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. This may include, for example, a local area network (LAN) or a wide area network (WAN), or the connection may be made to an external computer (for example, through the Internet using an Internet Service Provider). Additionally, in embodiments, the present disclosure may be embodied in a field programmable gate array (FPGA).

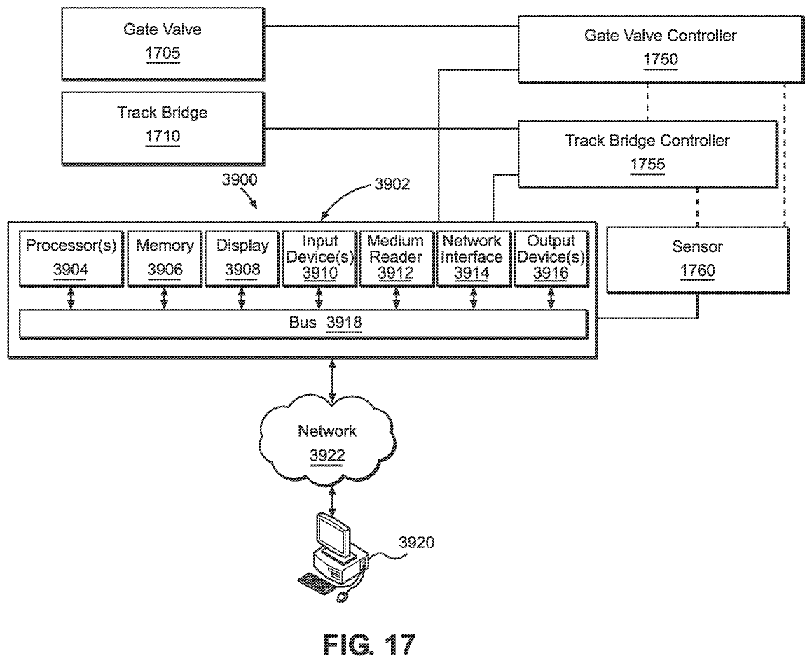

FIG. 17 is an exemplary system for use in accordance with the embodiments described herein. The system 3900 is generally shown and may include a computer system 3902, which is generally indicated. The computer system 3902 may operate as a standalone device or may be connected to other systems or peripheral devices. For example, the computer system 3902 may include, or be included within, any one or more computers, servers, systems, communication networks or cloud environment.

The computer system 3902 may operate in the capacity of a server in a network environment, or in the capacity of a client user computer in the network environment. The computer system 3902, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 3902 is illustrated, additional embodiments may include any collection of systems or sub-systems that individually or jointly execute instructions or perform functions.

As illustrated in FIG. 17, the computer system 3902 may include at least one processor 3904, such as, for example, a central processing unit, a graphics processing unit, or both. The computer system 3902 may also include a computer memory 3906. The computer memory 3906 may include a static memory, a dynamic memory, or both. The computer memory 3906 may additionally or alternatively include a hard disk, random access memory, a cache, or any combination thereof. Of course, those skilled in the art appreciate that the computer memory 3906 may comprise any combination of known memories or a single storage.

As shown in FIG. 17, the computer system 3902 may include a computer display 3908, such as a liquid crystal display, an organic light emitting diode, a flat panel display, a solid state display, a cathode ray tube, a plasma display, or any other known display. The computer system 3902 may include at least one computer input device 3910, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 3902 may include multiple input devices 3910. Moreover, those skilled in the art further appreciate that the above-listed, exemplary input devices 3910 are not meant to be exhaustive and that the computer system 3902 may include any additional, or alternative, input devices 3910.

The computer system 3902 may also include a medium reader 3912 and a network interface 3914. Furthermore, the computer system 3902 may include any additional devices, components, parts, peripherals, hardware, software or any combination thereof which are commonly known and understood as being included with or within a computer system, such as, but not limited to, an output device 3916. The output device 3916 may be, but is not limited to, a speaker, an audio out, a video out, a remote control output, or any combination thereof. As shown in FIG. 17, the computer system 3902 may include communication and/or power connections to a gate valve 1705, a gate valve controller 1750 to control the gate valve 1705 (e.g., open and close the gate valve door), a track bridge 1710, a track bridge controller 1755 to control the track bridge 1710 (e.g., raise and lower the track bridge) in accordance with aspects of the disclosure. Additionally, as shown in FIG. 17, the computer system 3902 may include one or more sensors 1760 (e.g., positional sensors, GPS systems, magnetic sensors, cameras) that may provide data (e.g., positional data) to the gate valve controller 1750 and/or the track bridge controller 1755.

Furthermore, the aspects of the disclosure may take the form of a computer program product accessible from a computer-usable or computer-readable medium providing program code for use by or in connection with a computer or any instruction execution system. The software and/or computer program product can be implemented in the environment of FIG. 17. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Accordingly, the present disclosure provides various systems, structures, methods, and apparatuses. Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular materials and embodiments, embodiments of the disclosure are not intended to be limited to the particulars disclosed; rather the disclosure extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk, tapes or other storage device to capture carrier wave signals such as a signal communicated over a transmission medium. Accordingly, the disclosure is considered to include any computer-readable medium or other equivalents and successor media, in which data or instructions may be stored.

While the specification describes particular embodiments of the present disclosure, those of ordinary skill can devise variations of the present disclosure without departing from the inventive concept.

One or more embodiments of the disclosure may be referred to herein, individually and/or collectively, by the term “invention” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While the disclosure has been described with reference to specific embodiments, those skilled in the art will understand that various changes may be made and equivalents may be substituted for elements thereof without departing from the true spirit and scope of the disclosure. While exemplary embodiments are described above, it is not intended that these embodiments describe all possible forms of the embodiments of the disclosure. Rather, the words used in the specification are words of description rather than limitation, and it is understood that various changes may be made without departing from the spirit and scope of the disclosure. In addition, modifications may be made without departing from the essential teachings of the disclosure. Furthermore, the features of various implementing embodiments may be combined to form further embodiments of the disclosure.

Insofar as the description above and the accompanying drawing disclose any additional subject matter that is not within the scope of the claims below, the embodiments are not dedicated to the public and the right to file one or more applications to claim such additional embodiments is reserved.

Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Accordingly, the present disclosure provides various systems, structures, methods, and apparatuses. Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular materials and embodiments, embodiments of the invention are not intended to be limited to the particulars disclosed; rather the invention extends to all functionally equivalent structures, methods, and uses such as are within the scope of the appended claims.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

What is claimed is:

1. A gate valve comprising:
a gate valve door moveable between an open position and a closed position; and
a track bridge moveable between a lowered active position, and a raised inactive position,
wherein when the track bridge is in the raised position, the gate valve can be moved from the open position to the closed position.

2. The gate valve of claim 1, further comprising a track frame in which the track bridge is moveable between the lowered position and the raised position.

3. The gate valve of claim 2, wherein the track bridge comprises a track support and side supports arranged on each side of the track support, wherein the side supports are perpendicular to the track support.

4. The gate valve of claim 3, wherein each of the side supports includes a lower portion extending below the track support.

5. The gate valve of claim 4, wherein each of the lower portions includes a projection that projects outwardly from a lower end of the lower portion in a direction parallel to an extension direction of the track support.

6. The gate valve of claim 5, further comprising a first projection foot which projects outwardly from the projection in a direction perpendicular to an extension direction of the track support, and a second projection foot which projects outwardly from the projection in a direction perpendicular to the extension direction of the track support and opposite the first projection foot.

7. The gate valve of claim 6, wherein the first projection foot and the second projection foot each comprise a planar contact surface for engagement with respective frame planar contact surfaces of the track frame.

8. The gate valve of claim 7, further comprising a padding arranged on at least one of the planar contact surfaces a hard contact arranged on at least one of the planar contact surfaces.

9. The gate valve of claim 6, wherein at least one of the first projection foot and the second projection foot comprises a tapering contact surface for engagement with respective frame tapering contact surface of the track frame.

10. The gate valve of claim 5, wherein the projection projects outwardly from a lower end of the lower portion in a direction perpendicular to an extension direction of the track support.

11. The gate valve of claim 10, wherein the projection comprises a lopsided diamond-shaped petal.

12. The gate valve of claim 4, wherein each of the side supports further includes an upper portion extending above the track support.

13. The gate valve of claim 2, wherein the track frame includes projection guideways operable to accommodate respective projections of the track bridge through a range of movement of the track bridge between the lowered position and the raised position.

14. The gate valve of claim 13, wherein the respective projections of the track bridge arranged in the projection guideways prevent rotation of the track bridge through the range of movement of the track bridge between the lowered position and the raised position.

15. The gate valve of claim 1, further comprising at least one of guidance tracks, levitation tracks, c-cores, and supplemental braking tracks arranged on the track bridge.

16. The gate valve of claim 1, further comprising transfer balls arranged on the track bridge.

17. The gate valve of claim 1, further comprising:
a first actuator to move the track bridge in a vertical direction between the lowered position and the raised position; and
a second actuator operable to move the gate valve between the open position and the closed position.

18. A method of operating a gate valve comprising a gate valve door moveable between an open position and a closed position; and a track bridge moveable between a lowered active position, and a raised inactive position, the method comprising:
raising the track bridge from the lowered active position to the raised inactive position; and
moving the gate valve door from the open position to the closed position to seal the gate valve.

19. The method of claim 18, further comprising:
moving the gate valve door from the closed position to the open position; and
lowering the track bridge from the raised inactive position to the lowered active position so that one or more tracks on the track bridge align with adjacent tracks on each side of the gate valve.

20. The method of claim 19, wherein the one or more tracks on the track bridge comprise at least one of guidance tracks, levitation tracks, c-cores, and supplemental braking tracks.
